(19) United States
(12) Patent Application Publication
(10) Pub. No.: US 2025/0130143 A1
(43) Pub. Date: Apr. 24, 2025

(54) DEVICES AND COMPONENTS FOR AUTOMATED TISSUE PROCESSING AND STAINING AND USES THEREOF

(71) Applicant: Jin V. WU

(72) Inventor: Jin V. WU

(21) Appl. No.: 17/905,083

(22) PCT Filed: Mar. 11, 2020
(86) PCT No.: PCT/CN2021/079901

§ 371 Date: Aug. 26, 2022

(30) Foreign Application Priority Data
Mar. 11, 2020 (WO) PCT/CN2020/078752
May 17, 2020 (CN) 202020863635.5
Jun. 17, 2020 (CN) 202021122240.6
Jun. 17, 2020 (CN) 202021122914.2
Sep. 4, 2020 (CN) 202010919863.4

(51) Int. Cl. G01N 1/31; G01N 35/04

(52) U.S. Cl. CPC G01N 1/31; G01N 35/04; G01N 2035/0441; G01N 2035/0444

(57) ABSTRACT

A tissue staining device (100) comprises: (a) a microscope slide carousel (105), wherein the microscope slide carousel (105) is configured to rotate on a first axis of rotation (230), and wherein the microscope slide carousel (105) comprises at least one microscope slide cartridge stall (106), and (b) a reagent assembly (110) comprising: (i) a reagent carousel (113), wherein the reagent carousel (113) is configured to rotate on a second axis of rotation (310), and wherein the reagent carousel (113) comprises at least one reagent holder, (ii) a dispensing actuator (115), and wherein the reagent carousel (113) is positioned above the microscope slide carousel (105), and wherein the reagent carousel (113) and the microscope slide carousel (105) are positioned such that when a reagent is placed in the reagent carousel (113) the reagent can flow from the reagent carousel (113) to the microscope slide carousel (105).

This application is a national stage application of International Patent Application No. PCT Application No. PCT/CN2021/079901, filed on Mar. 10, 2021, which claims priority from the International Patent Application No. PCT/CN2020/078752, from Chinese Patent Application No. CN202010919863.4, filed Sep. 4, 2020, CN202021122914.2 filed Jun. 17, 2020, CN202021122240.6, filed Jun. 17, 2020, and CN202020863635.5, filed May 21, 2020. The entirety of the aforementioned applications are incorporated herein by reference.

### FIELD

The present disclosure is directed to devices, and components thereof, for automated tissue sample processing. Also provided in other aspects of the disclosure are methods of use, systems, and kits of the devices and components thereof.

### BACKGROUND

Chemical staining, such as hematoxylin and eosin (H&E) staining, and immuno-staining, such as immunohistochemical (IHC) staining, of tissue samples is a reliable technique for assessing the presence, or lack thereof, of cellular features and target antigens, such as proteins. Application of these techniques during medical procedures, such as intraoperatively, may provide a valuable source of information for improving patient treatments and outcomes. For example, tissue biopsy samples may be removed from a patient during surgery and then sent to a pathology laboratory for analysis by a frozen tissue section technique. Identification of specific cellular features and proteins in the tissue samples may help a pathologist intraoperatively diagnose numerous tissue pathologies, including, e.g., sentinel lymph node biopsies (for potential metastatic carcinomas and melanomas), undifferentiated tumors (potential carcinomas, lymphomas, and melanomas), and biopsies of margins (looking at the edges of excised tissue to see if the entire tumor has been removed).

Certain attributes and standards of chemical and/or immuno-staining techniques, such as speed and reliability, must be satisfied to allow for the use of such techniques during a medical procedure. For example, intraoperative guidelines, such as those provided by the College of American Pathologists, typically recommend reporting pathology data to the surgeon within approximately 20 minutes after tissue sample harvesting. However, many conventional IHC techniques require 60 to 120 minutes to process the tissue sample and complete the staining procedure. And, the time required for performing a tissue staining protocol comprising an immuno-staining technique may increase depending on, e.g., the speed of the technician processing the tissue sample and whether more than one target antigen is assessed and/or chemical staining is also applied to the tissue sample.

Direct immuno-staining techniques, such as direct IHC, have reduced the time necessary to complete tissue staining methods comprising an immuno-staining protocol. See U.S. Patent Publication No. 20170074867, which is hereby incorporated herein by reference in its entirety. Complementary technologies directed to, e.g., facilitating the ease of completing a tissue staining protocol, such as by reducing required human-performed steps, reducing the total time of a tissue staining protocol, improving staining consistency, and reducing immuno-staining reagent usage and associated costs, are needed to allow for and improve the use of tissue processing and staining techniques.

All references cited herein, including patent applications and publications, are incorporated by reference in their entirety.

### SUMMARY

In one aspect, the present application provides a tissue staining device comprising: (a) a reagent assembly comprising: (i) a reagent carousel, wherein the reagent carousel is configured to rotate on a first axis of rotation, and wherein the reagent carousel comprises at least one reagent holder, (ii) a dispensing actuator, and (b) a microscope slide carousel, wherein the microscope slide carousel is configured to rotate on a second axis of rotation, and wherein the microscope slide carousel comprises at least one microscope slide cartridge stall, wherein the reagent carousel is positioned above the microscope slide carousel, and wherein the reagent carousel and the microscope slide carousel are positioned such that when a reagent is placed in the reagent carousel the reagent can flow from the reagent carousel to the microscope slide carousel.

In some embodiments, the directionality of the flow of the reagent is based on gravitational force. In some embodiments, the reagent flow represents an imaginary reagent dispensing axis, wherein the reagent dispensing axis, the first axis of rotation, and the second axis of rotation are substantially parallel. In some embodiments, the first axis of rotation and the second axis of rotation are not co-axial.

In some embodiments, the microscope slide carousel comprises 4 to 20 microscope slide cartridge stalls. In some embodiments, each microscope slide cartridge stall is configured to hold a microscope slide cartridge assembly. In some embodiments, the microscope slide cartridge stall is configured to hold the microscope slide cartridge assembly such that a face of a microscope slide in the microscope slide cartridge assembly is in a substantially horizontal position. In some embodiments, the microscope slide cartridge stall comprises an opening having a size that is based on the dimensions of the microscope slide. In some embodiments, a proximal portion of the microscope slide cartridge stall comprises a loading spring. In some embodiments, a distal portion of the microscope slide cartridge stall is configured to interface with a locking clip on the microscope slide cartridge assembly.

In some embodiments, the tissue staining device described herein further comprises the microscope slide cartridge assembly. In some embodiments, the microscope slide cartridge assembly comprises: (a) fluid input port positioned on a top side of the microscope slide cartridge assembly; (b) a gasket positioned on a bottom side of the microscope slide cartridge assembly, wherein the gasket is configured to form a sealed perimeter on a face of a microscope slide; (c) one or more walls, wherein the one or more walls are configured to connect, at least in part, the top side and the gasket thereby forming a chamber over a face of the microscope slide; (d) one or more clips configured to hold the face of the microscope slide against the gasket; (e) a portion of a locking clip; (f) an inclined waste flow pathway configured to direct fluid flow from the chamber to a waste output element; and (g) a microscope slide. In some embodiments, the microscope slide cartridge assembly further comprises a microscope slide covertile configured to be positioned on the microscope slide. In some embodiments, the microscope slide covertile comprises one or more downward protruding spacers. In some embodiments, each of the one or more downward protruding spacers has a height of about 0.05 mm to about 0.5 mm. In some embodiments, the microscope slide covertile, when positioned on the microscope slide, forms a space configured to hold about 50 μL to 200 μL of a fluid. In some embodiments, the portion of the locking clip of the microscope slide cartridge assembly is configured to interface with another portion of the locking clip located on a microscope slide cartridge stall. In some embodiments, the fluid input port is on a proximal portion of the microscope slide cartridge assembly, and the portion of the locking clip is on a distal portion of the microscope slide cartridge assembly. In some embodiments, the chamber has a volume of about 300 μL or more. In some embodiments, the sealed perimeter formed on the microscope slide by the gasket has an area of 1 cm² to 10 cm². In some embodiments, the microscope slide cartridge assembly comprises a fluid input port position on a top side of the microscope slide cartridge assembly, and wherein when the microscope slide cartridge assembly is loaded in the microscope slide cartridge stall the reagent flow from the reagent carousel to the microscope slide carousel is directed to the fluid input port.

In some embodiments, the microscope slide carousel further comprises a first rotary control mechanism comprising a first rotary actuator. In some embodiments, the first rotary actuator is a rotary stepper motor. In some embodiments, the first rotary control mechanism is configured to rotate the microscope slide carousel 360° on the second axis of rotation. In some embodiments, the microscope slide carousel is configured to rotate on the second axis of rotation in any direction. In some embodiments, the microscope slide carousel is configured to rotate on the second axis of rotation at variable rotation speeds.

In some embodiments, the microscope slide carousel further comprises a microscope slide carousel waste reservoir. In some embodiments, the microscope slide carousel waste reservoir is in fluid communication with each microscope slide cartridge stall. In some embodiments, the microscope slide carousel waste reservoir further comprises a waste removal outlet. In some embodiments, the microscope slide carousel further comprises at least one pre-wash inlet.

In some embodiments, the microscope slide carousel further comprises a heating element, wherein the heating element is positioned in proximity to the microscope slide of the microscope slide cartridge assembly.

In some embodiments, the microscope slide carousel further comprises a temperature sensing element, wherein the temperature sensing element is positioned in proximity to the microscope slide of the microscope slide cartridge assembly.

In some embodiments, the reagent carousel comprises between about 5 and about 20 reagent holders. In some embodiments, each reagent holder is configured to hold a reagent bottle in a pre-specified orientation. In some embodiments, each reagent holder comprises a depression to accept the reagent bottle in the pre-specified orientation.

In some embodiments, the tissue staining devices described herein further comprises the reagent bottle. In some embodiments, the reagent bottle comprises: (a) a reagent reservoir; (b) a mounting element; and (c) a dispensing element, wherein the dispensing element comprises a press-to-dispense assembly and a reagent outlet. In some embodiments, the press-to-dispense assembly is configured to dispense about 50 μL to about 200 μL per press. In some embodiments, the reagent reservoir has a volume of about 5 mL to about 30 mL. In some embodiments, the reagent bottle further comprise one portion of a locking clip. In some embodiments, the one portion of the locking clip of the reagent bottle is positioned on the mounting element. In some embodiments, the reagent bottle described herein further comprises a barcode label. In some embodiments, the barcode label is positioned on the mounting element.

In some embodiments, the reagent assembly further comprises a second rotary control mechanism comprising a stationary actuator positioned relative to the first axis of rotation. In some embodiments, the second rotary control mechanism is a rotary stepper motor.

In some embodiments, the dispensing actuator comprises a central body coupled to a dispensing arm, wherein the dispensing actuator comprises an arm movement mechanism configured to move the dispensing arm in a direction substantially parallel with the reagent dispensing axis. In some embodiments, the dispensing arm extends from the central body of the dispensing actuator to over at least a portion of the reagent carousel. In some embodiments, the dispensing arm extends from the central body of the dispensing actuator to over at least a portion of each reagent holder.

In some embodiments, the reagent assembly comprises at least one common liquid dispenser comprising a liquid dispenser output port and at least one liquid pump. In some embodiments, the liquid dispenser output port is positioned such that when a liquid is dispensed from the liquid dispenser output port the liquid can flow from the liquid dispenser output port to the input port of the microscope slide cartridge assembly on the microscope slide carousel. In some embodiments, the directionality of the flow of the liquid is based on gravitational force. In some embodiments, the liquid flow represents an imaginary liquid dispensing axis, wherein the liquid dispensing axis, the first axis of rotation, and the second axis of rotation are substantially parallel.

In some embodiments, the tissue staining device described herein further comprises one or more camera or detectors configured to image and read a barcode label.

In some embodiments, the tissue staining device described herein further comprises a bulk solution rack.

In some embodiments, the tissue staining device described herein further comprises a waste receptacle, wherein the waste receptacle is fluidically connected to the waste removal outlet of the microscope slide carousel.

In some embodiments, the tissue staining device described herein further comprises one or more liquid pumps.

In some embodiments, the tissue staining device described herein further comprises a control unit. In some embodiments, the control unit comprises one or more processors and memory storing one or more programs, the one or more programs configured to be executed by the one or more processors, the one or more programs including instructions for: (i) positioning the reagent carousel and/or positioning the microscope slide carousel; (ii) enacting the dispensing actuator; and (iii) performing a tissue staining protocol and/or performing a tissue dehydration protocol.

In some embodiments, the tissue staining device described herein further comprises a user interface component.

In another aspect, the present application provides a microscope slide cartridge assembly comprising: (a) fluid input port positioned on a top side of the microscope slide cartridge assembly; (b) a gasket positioned on a bottom side of the microscope slide cartridge assembly, wherein the gasket is configured to form a sealed perimeter on a face of a microscope slide; (c) one or more walls, wherein the one or more walls are configured to connect, at least in part, the top side and the gasket thereby forming a chamber over a face of the microscope slide; (d) one or more clips configured to hold the face of the microscope slide against the gasket; (e) a portion of a locking clip; and (f) an inclined waste flow pathway configured to direct fluid flow from the chamber to a waste output element. In some embodiments, the portion of the locking clip is configured to interface with another portion of the locking clip located on a microscope slide cartridge stall. In some embodiments, the fluid input port is on a proximal portion of the microscope slide cartridge assembly, and the portion of the locking clip is on a distal portion of the microscope slide cartridge assembly. In some embodiments, the chamber has a volume of 300 μL or more. In some embodiments, the sealed perimeter formed by the gasket has an area of 1 cm² to 10 cm². In some embodiments, the microscope slide cartridge assembly further comprises the microscope slide. In some embodiments, the microscope slide cartridge assembly further comprises a microscope slide covertile configured to be positioned on the microscope slide. In some embodiments, the microscope slide covertile comprises one or more downward protruding spacers. In some embodiments, each of the one or more downward protruding spacers has a height of about 0.05 mm to about 0.5 mm. In some embodiments, the microscope slide covertile, when positioned on the microscope slide, forms a space configured to hold about 40 μL to 200 μL of a fluid.

In another aspect, the present application provides a method of staining a tissue sample, the method comprising: (a) placing a microscope slide cartridge assembly in a microscope slide stall of a tissue staining device described herein, wherein the microscope slide cartridge assembly is interfaced with a microscope slide comprising the tissue sample; and (b) initiating the tissue staining device to perform a tissue staining protocol, thereby staining the tissue sample.

In some embodiments, the method described herein further comprises selecting the tissue staining protocol. In some embodiments, the tissue staining protocol comprises a chemical staining protocol. In some embodiments, the tissue staining protocol comprises an immunohistochemical (IHC) staining protocol or an immunocytochemical (ICC) staining protocol. In some embodiments, the method described herein further comprises a microscope slide mounting method.

In some embodiments, the tissue staining protocol comprises: (a) dispensing a reagent from the reagent carousel to the microscope slide; (b) rotating the microscope slide carousel such that the reagent fully coats the tissue sample; (c) dispensing a wash buffer from the common liquid dispenser to the microscope slide; and (d) rotating the microscope slide carousel such that a solution comprising the wash buffer is moved to the waste removal outlet of the microscope slide carousel via the waste flow element.

### BRIEF DESCRIPTION OF THE DRAWINGS

FIGS. 1A-1D show select views of a 3-dimensional (3D) model of an exemplary tissue staining device 100.

FIG. 2 shows a cross-sectional view of a 3D model of aspects of an exemplary microscope slide carousel.

FIG. 3 shows a view of a 3D model of aspects of an exemplary reagent assembly.

FIG. 4A shows a view of a 3D model of an exemplary microscope slide cartridge assembly 106. FIG. 4B shows a cross-sectional view of a 3D model of aspects of an exemplary microscope slide cartridge assembly 106. FIG. 4C shows a view of a 3D model of an exemplary microscope slide cartridge assembly 106. FIG. 4D shows a cross-sectional view of a 3D model of aspects of an exemplary microscope slide cartridge assembly 106. FIG. 4E shows a view of a 3D model of an exemplary microscope slide coverslip 460. FIG. 4F shows a cross-sectional view of a 3D model of aspects of an exemplary microscope slide cartridge assembly 106.

FIG. 5A shows a view of a 3D model of an exemplary reagent bottle 111. FIG. 5B shows a cross-sectional view of a 3D model of aspects of an exemplary reagent bottle 111.

FIGS. 6A and 6B show images of an exemplary tissue staining device described herein.

### DETAILED DESCRIPTION

The present application provides, in some aspects, devices for improved processing of one or more tissue samples. The present disclosure is based, at least in part, on the finding that the integration of features into the devices described herein, such as a reagent assembly and a microscope slide carousel housing one or more microscope slide cartridge assemblies, allow for simplified, rapid, and efficient automated tissue processing. The disclosed devices comprise a flexible and efficient fluid management system, which is capable of, e.g., uniform application of reagent(s) and/or solution(s) on a tissue sample using a minimal fluid volume, mixing of reagent(s) and/or solution(s), and removal of reagent(s) and/or solution(s). As disclosed in more detail in the sections below, fluid management is achieved, in part, by controlled rotation (such as speed, direction, and duration) of the microscope slide carousel on the first axis of rotation. In some embodiments, the devices described herein further comprise means for delivery of a low-volume amount of a reagent from the reagent carousel to a tissue sample on the microscope slide carousel in a non-contact manner with minimal reagent loss. Such devices greatly reduce use of reagents thereby reducing waste and costs. In some embodiments, the devices described herein have a small footprint, and are, e.g., bench-top or table-top devices.

The devices of the present application may comprise certain components and combinations thereof to attain any combination of the functionalities and advantages taught herein, thereby providing a device useful for a diverse array of applications, including, e.g., rapid intraoperative applications.

The present application also provides, in other aspects, methods of using the devices described herein, systems comprising the devices described herein, and kits of the devices described herein and components thereof.

### I. Definitions

The term “tissue sample,” as used herein, encompasses any sample derived or originating from an organism or a tissue thereof, including a sample comprising one or more of a cell, a cellular component, and material derived or excreted from a cell, tissue, or organism. For example, the tissue sample may be any tissue sample, cellular sample, or sub-cellular sample. In some embodiments, the tissue sample is a formalin-fixed-paraffin-embedded tissue section, a frozen tissue section, an aged tissue sample, a fresh tissue or cell block section, a fresh tissue smear (e.g., obtained via core or fine needle biopsy), a fresh tissue sample obtained via touch imprint, fresh cells from a circulating isolation process (e.g., magnetic beads affinity separation, filtration, flow cytometry), fresh cells from cell cultures, explants, fresh cells isolated from other isolation processes, and fresh micro vesicles, exosomes, or other sub cellular organelles or fragments. In some embodiments, the tissue sample is a cytology sample. In some embodiments, the cytology sample comprises a clinical smear, a fresh tissue smear, a fresh tissue sample obtained via touch imprint, fresh cells obtained from a circulating isolation process, fresh cells obtained from cell cultures, explants, fresh cells isolated from other isolation processes, fresh micro-vesicles, exosomes, or other sub-cellular organelles or fragments, a body fluid, a body secretion, bronchial alveolar lavage fluid, or cerebrospinal fluid. In some embodiments, the cytology sample comprises a cellular component sample. In some embodiments, the cellular component sample comprises one or more of the following: micro-vesicles, exosomes, cellular debris, a membrane fragments, and a cellular organelle, or a fragment thereof. In some embodiments, the tissue sample comprises an excretion, such as an excretion from an organism or a tissue thereof.

The terms “comprising,” “having,” “containing,” and “including,” and other similar forms, and grammatical equivalents thereof, as used herein, are intended to be equivalent in meaning and to be open ended in that an item or items following any one of these words is not meant to be an exhaustive listing of such item or items, or meant to be limited to only the listed item or items. For example, an article “comprising” components A, B, and C can consist of (i.e., contain only) components A, B, and C, or can contain not only components A, B, and C but also one or more other components. As such, it is intended and understood that “comprises” and similar forms thereof, and grammatical equivalents thereof, include disclosure of embodiments of “consisting essentially of” or “consisting of.”

Where a range of values is provided, it is understood that each intervening value, to the tenth of the unit of the lower limit, unless the context clearly dictate otherwise, between the upper and lower limit of that range and any other stated or intervening value in that stated range, is encompassed within the disclosure, subject to any specifically excluded limit in the stated range. Where the stated range includes one or both of the limits, ranges excluding either or both of those included limits are also included in the disclosure.

Reference to “about” a value or parameter herein includes (and describes) variations that are directed to that value or parameter per se. For example, description referring to “about X” includes description of “X.”

As used herein, including in the appended claims, the singular forms “a,” “or,” and “the” include plural referents unless the context clearly dictates otherwise.

It will also be understood by those skilled in the art that changes in the form and details of the subject matter described herein may be made without departing from the scope of this disclosure. In addition, although various advantages, aspects, and objects have been described with reference to various implementations, the scope of this disclosure should not be limited by reference to such advantages, aspects, and objects. Rather, the scope of this disclosure should be determined with reference to the appended claims.

### II. Tissue Staining Devices

The present disclosure provides devices designed to integrate features, such as a microscope slide carousel and a reagent assembly, in a manner that enables and simplifies rapid automated tissue processing using forces generated by rotation of the microscope slide carousel on a first axis of rotation. Fluid management by the tissue staining devices described herein is achieved by controlled rotation (such as speed, direction, and duration) of the microscope slide carousel on the first axis of rotation, thereby providing, e.g., uniform application of reagent(s) and/or solution(s) on a tissue sample using a minimal fluid volume thereof, mixing of reagent(s) and/or solution(s), and removal of reagent(s) and/or solution(s).

Thus, in some embodiments, described herein is a tissue staining device comprising: (a) a microscope slide carousel, wherein the microscope slide carousel is configured to rotate on a first axis of rotation, and (b) a reagent assembly comprising a reagent carousel, wherein the reagent carousel is positioned above the microscope slide carousel, and wherein the reagent carousel and the microscope slide carousel are positioned such that when a reagent is placed in the reagent carousel (such as in a reagent bottle), the reagent has a path to flow from the reagent carousel to the microscope slide carousel.

In some embodiments, described herein is a tissue staining device comprising: (a) a microscope slide carousel, wherein the microscope slide carousel is configured to rotate on a first axis of rotation, and wherein the microscope slide carousel comprises at least one microscope slide cartridge stall, and (b) a reagent assembly comprising: (i) a reagent carousel, wherein the reagent carousel is configured to rotate on a second axis of rotation, and wherein the reagent carousel comprises at least one reagent holder, (ii) a dispensing actuator, wherein the reagent carousel is positioned above the microscope slide carousel, and wherein the reagent carousel and the microscope slide carousel are positioned such that when a reagent is placed in the reagent carousel (such as in a reagent bottle), the reagent has a path to flow from the reagent carousel to the microscope slide carousel. In some embodiments, the first axis of rotation and the second axis of rotation are substantially parallel.

In some embodiments, the tissue staining devices described herein are designed, at least in part, to enable delivery of one or more reagents from a reagent carousel to a tissue sample on a microscope slide carousel, wherein the reagent carousel is positioned above the microscope slide carousel, and wherein the reagent carousel and the microscope slide carousel are positioned such that when a reagent is placed in the reagent carousel (such as in a reagent bottle), the reagent has a path to flow from the reagent carousel to the microscope slide carousel. In some embodiments, the delivery of a reagent from a reagent carousel to a tissue sample on a microscope slide carousel is performed in a non-contact manner, i.e., the source of the reagent, e.g., a reagent bottle, does not contact the microscope slide carousel, a microscope slide cartridge assembly, or a component thereof. Such embodiments avoid contamination or the need to use a disposable pipette tip, or a similar feature, for each, or a set of, reagent aliquot(s). In some embodiments, the reagent assembly comprises a port, wherein the port is configured to create a flow path for a reagent from the reagent carousel to the microscope slide carousel. In some embodiments, the port is configured such that a reagent does not contact the port, e.g., the port is a hole in the reagent assembly that exposes a path from the reagent carousel to the microscope slide carousel. In some embodiments, the port is configured to guide the reagent from the reagent carousel to the microscope slide carousel, e.g., wherein the port comprises a funnel-type design.

In some embodiments, the tissue staining devices described herein are designed, at least in part, to be placed on a substantially level (horizontally) surface, e.g., a lab bench or table top. In some embodiments, the directionality of the flow of the reagent from the reagent carousel to the microscope slide carousel is based on gravitational force. In some embodiments, the reagent flow represents an imaginary reagent dispensing axis, wherein the reagent dispensing axis and the first axis of rotation are substantially parallel. In some embodiments, the reagent flow represents an imaginary reagent dispensing axis, wherein the reagent dispensing axis and the second axis of rotation are substantially parallel. In some embodiments, the reagent flow represents an imaginary reagent dispensing axis, wherein the reagent dispensing axis, the first axis of rotation, and the second axis of rotation are substantially parallel. In some embodiments, the reagent flow represents an imaginary reagent dispensing axis, wherein the reagent dispensing axis passes through the reagent assembly port configured to create a flow path for a reagent from the reagent carousel to the microscope slide carousel.

In some embodiments, the tissue staining devices described herein are designed, at least in part, to allow for microscope slides to be loaded into a microscope slide carousel. In some instances, such a feature may guide the positioning of the microscope slide carousel relative to the reagent carousel. In some embodiments, the first axis of rotation and the second axis of rotation are not co-axial. In some embodiments, the first axis of rotation and the second axis of rotation are separated by a distance (such as horizontally or vertically) that allows for an access space such that a microscope slide cartridge assembly can be loaded into the microscope slide carousel.

In some embodiments, the first axis of rotation and the second axis of rotation are co-axial. In some embodiments, wherein the first axis of rotation and the second axis of rotation are co-axial, the microscope slide carousel and the reagent carousel are relatively positioned to provide an access space such that a microscope slide can be loaded into the microscope slide carousel. In some embodiments, wherein the first axis of rotation and the second axis of rotation are co-axial, the microscope slide carousel and/or the reagent carousel comprise a feature, such as a means to move the component, to provide an access space such that a microscope slide cartridge assembly can be loaded into the microscope slide carousel.

These and other components of the devices, including bulk solution racks, liquid pumps, waste receptacles, and control units, disclosed herein will now be described below in more detail. Description of the devices or components thereof in a modular fashion is not intended to limit the scope of the disclosure of the present application. One of ordinary skill in the art will readily understand that the devices of the present application encompass a multitude of functional embodiments comprising any combination of one or more of the elements taught herein. Materials suitable for the devices and components disclosed herein are generally known, and may be selected based on the needs of the device or the component, such as needs due to forces exerted on the device or the component and/or exposure to certain reagents and fluids. In some embodiments, the materials(s) used to construct components of the device are suitable for injection molding.

In some embodiments, the devices disclosed herein may be described by way of, e.g., distances and/or volumes, which are measurements provided as illustrative examples and are not to be construed as limiting the scope and/or design of functional concepts taught in the present disclosure. In some embodiments, a device, or a component thereof, is described by naming specific aspects thereof, however, the use of a name for a specific aspect does not mean that such specific aspect is readily separable from the whole. In some embodiments, the delineation of a specific aspect from the whole may be arbitrarily selected.

### A. Microscope Slide Carousel

The devices described herein comprise a microscope slide carousel comprising at least one microscope slide cartridge stall, wherein the microscope slide carousel is configured to rotate on a first axis of rotation. Also provided herein are microscope slide cartridges and other useful elements that may be included or associated with the microscope slide carousel.

i. Microscope Slide Cartridge Stall

In some embodiments, the microscope slide carousels described herein are designed, at least in part, to receive and hold a microscope slide during all processing completed by the devices described herein, wherein the microscope slide is held in a microscope slide cartridge stall. The microscope slide carousels described herein may be designed with a range of the number of microscope slide cartridge stalls positioned thereon. In some embodiments, the number of microscope slide cartridge stalls is based on, e.g., one or more of the desired size of the tissue staining device, rotational speed requirement for the microscope slide carousel, number of sequential dispensing actions, and clinical and application needs. In some embodiments, the microscope slide carousel comprises about 4 to about 20, such as any of about 4 to about 10, about 4 to about 15, about 6 to about 15, about 10 to about 15, about 10 to about 20, microscope slide cartridge stalls. In some embodiments, the microscope slide carousel comprises at least 4, such as at least any of 5, 6, 7, 8, 9, 10, 11, 12, 13, 14, 15, 16, 17, 18, or 19, microscope slide cartridge stalls. In some embodiments, the microscope slide carousel comprises 20 or fewer, such any of 19 or fewer, 18 or fewer, 17 or fewer, 16 or fewer, 15 or fewer, 14 or fewer, 13 or fewer, 12 or fewer, 11 or fewer, 10 or fewer, 9 or fewer, 8 or fewer, 7 or fewer, 6 or fewer, or 5 or fewer, microscope slide cartridge stalls. In some embodiments, the microscope slide carousel comprises any of 4, 5, 6, 7, 8, 9, 10, 11, 12, 13, 14, 15, 16, 17, 18, 19, or 20 microscope slide cartridge stalls.

The devices and components described herein may be configured to accommodate microscope slides of any size and shape, including, but not limited to, a standard microscope slide, which are substantially rectangular and measure about 3 inches by about 1 inch. The devices and components described herein may also be configured to accommodate microscope slides of any material, such as a glass, a polymer, a plastic, or a metal. In some embodiments the microscope slide size and/or material are based on the tissue sample and/or processing protocol to be performed thereon (e.g., such that it is compatible with a reagent).

In some embodiments, the microscope slide cartridge stall comprises an opening having a size that is based on the dimensions of the microscope slide and microscope slide cartridge assembly. In some embodiments, the microscope slide cartridge stall comprises an opening with a clearance to the edge of a microscope slide of less than about 5 mm, such as less than about 4.5 mm, 4 mm, 3.5 mm, 3 mm, 2.5 mm, 2 mm, 1.5 mm, or 1 mm.

In some embodiments, the microscope slide cartridge stalls described herein are designed, at least in part, to hold a microscope slide cartridge assembly in a manner sufficient and compatible with the steps of (and forces exerted on the microscope slide cartridge assembly during) processing completed by the devices described herein. In some embodiments, each microscope slide cartridge stall is configured to hold a microscope slide cartridge assembly. In some embodiments, the microscope slide cartridge stall is configured to hold the microscope slide cartridge assembly such that a face of a microscope slide in the microscope slide cartridge assembly is in a substantially horizontal position. In some embodiments, the microscope slide is held in a microscope slide cartridge stall such that no lateral or vertical displacement occurs during tissue processing and device operation. In some embodiments, the proximal portion of the microscope slide cartridge stall (e.g., the portion of the microscope slide cartridge stall closest to the first axis of rotation) comprises a loading spring. In some embodiments, the loading spring is configured to apply a substantially horizontal force to the microscope slide in a direction that is away from the first axis of rotation. In some embodiments, the loading spring is configured with an element, such as a depression or a v-shaped structure, to resist vertical movement of a microscope slide when a microscope slide cartridge assembly is placed in the microscope slide cartridge stall. In some embodiments, the distal portion of the microscope slide cartridge stall is configured to interface with a locking clip on the microscope slide cartridge. In some embodiments, the microscope slide cartridge stall is configured to first interface with the microscope slide cartridge assembly via the locking clip on the microscope slide cartridge assembly, and subsequently interface with the microscope slide via the loading spring.

ii. Microscope Slide Cartridge and Assembly

In some aspects, the present disclosure provides a microscope slide cartridge, a microscope slide cartridge loaded with a microscope slide (i.e., a microscope slide cartridge assembly), and a device loaded with one or more microscope slide cartridge assemblies. The description of any of these components in isolation or in combination with another feature described herein is not meant to limit the disclosure of the component itself. For example, description of an embodiment of a microscope slide cartridge assembly loaded in a tissue staining device does not limit the disclosure provided for the description of a microscope slide cartridge or a microscope slide cartridge assembly described or claimed independently of the device.

In some embodiments, provided herein is a microscope slide cartridge configured to hold a microscope slide. In some embodiments, the microscope slide cartridge is configured based on a feature of a tissue sample (such as area or thickness), feature of a microscope slide (such as size or material), and/or a tissue processing protocol (such as a reagent used therein). As discussed herein, the devices and components described herein, such as microscope slide cartridges, may be configured to accommodate microscope slides of any size and shape, including, but not limited to, a standard microscope slide, which are substantially rectangular and measure about 3 inches by about 1 inch. The microscope slide cartridges described herein may also be configured to accommodate microscope slides of any material, such as a glass, a polymer, a plastic, or a metal. In some embodiments, the microscope slide comprises a label, such as for storing information regarding the microscope slide and/or tissue sample thereon. In some embodiments, the label comprises a barcode. In some embodiments, the label comprises a QR code. In some embodiments, the label comprises a codabar. In some embodiments, the label comprises a data matrix.

In some embodiments, the microscope slide cartridge comprises: (a) fluid input port positioned on a top side of the microscope slide cartridge assembly; (b) a gasket positioned on a bottom side of the microscope slide cartridge assembly, wherein the gasket is configured to form a sealed perimeter on a face of a microscope slide; (c) one or more walls, wherein the one or more walls are configured to connect, at least in part, the top side and the gasket thereby forming a chamber over a face of the microscope slide; (d) one or more clips configured to hold the face of the microscope slide against the gasket; (e) a portion of a locking clip; and (f) an inclined waste flow pathway configured to direct fluid flow from the chamber to a waste output element.

In some embodiments, the microscope slide cartridge assembly comprises: (a) fluid input port positioned on a top side of the microscope slide cartridge assembly; (b) a gasket positioned on a bottom side of the microscope slide cartridge assembly, wherein the gasket is configured to form a sealed perimeter on a face of a microscope slide; (c) one or more walls, wherein the one or more walls are configured to connect, at least in part, the top side and the gasket thereby forming a chamber over a face of the microscope slide; (d) one or more clips configured to hold the face of the microscope slide against the gasket; (e) a portion of a locking clip; (f) an inclined waste flow pathway configured to direct fluid flow from the chamber to a waste output element; and (g) a microscope slide.

In some embodiments, the microscope slide cartridge, and components thereof, including the fluidic input port, the one or more walls, the one or more clips, and the inclined waste flow pathway comprises a polymer material. In some embodiments, the polymer material is suitable for use in injection molding.

In some embodiments, the fluid input port is configured to direct the flow of a fluid, such as a reagent or a buffer, from an external source to the chamber over a face of the microscope slide. In some embodiments, the fluid input port is position on a top side of the microscope slide cartridge. In some embodiments, the fluid input port is position such that when the microscope slide cartridge assembly is loaded in the microscope slide cartridge stall the reagent flow from the reagent carousel to the tissue sample occurs via the fluid input port. In some embodiments, the fluid input port is configured to direct the flow of a fluid, such as a reagent or a buffer, from an external source to the chamber over a face of the microscope slide when the fluid is influenced by forces associated with the rotation of the microscope slide carousel on the first axis of rotation. In some embodiments, the fluid input port is configured to receive a fluid, such as a reagent. In some embodiments, the fluid input port comprises a bowl-shaped structure, wherein the top face is permanently open. In some embodiments, the reagent input port comprises a cylinder-shaped structure, wherein the top face is permanently open. In some embodiments, the reagent input port comprises a cone-shaped structure, wherein the tip of the cone, or narrowing end of the cone, points substantially downward, and wherein the top face is permanently open. In some embodiments, the fluid input port is on a proximal portion of the microscope slide cartridge assembly, wherein the proximal portion is the portion of the microscope slide cartridge assembly that is closest to the first axis of rotation when the microscope slide cartridge assembly is loaded in a microscope slide cartridge stall.

In some embodiments, the gasket is configured to form a desired area, including the shape thereof, on a microscope slide. The desired area delimited by the gasket component may be any size or shape, and may be configured based on specific requirements of a tissue sample, e.g., based on the size (such as defined by surface area and/or thickness) and/or shape of the tissue sample. In some embodiments, the area delimited by a gasket is smaller than the outer dimensions of a face of a microscope slide. In some embodiments, the gasket forms a circular or elliptical shape. In some embodiments, the gasket forms a rectangular shape. In some embodiments, the sealed perimeter formed on the microscope slide by the gasket has an area of about 1 cm² to about 10 cm², such as any of about 1 cm² to about 3 cm², about 1 cm² to about 5 cm², about 1 cm² to about 7 cm², about 3 cm² to about 5 cm², about 3 cm² to about 7 cm², about 3 cm² to about 10 cm², about 5 cm² to about 10 cm², or about 1 cm² to about 10 cm². In some embodiments, the sealed perimeter formed on the microscope slide by the gasket has an area of at least about 1 cm², such as at least about any of 1.5 cm², 2 cm², 2.5 cm², 3 cm², 3.5 cm², 4 cm², 4.5 cm², 5 cm², 5.5 cm², 6 cm², 6.5 cm², 7 cm², 7.5 cm², 8 cm², 8.5 cm², 9 cm², 9.5 cm², or 10 cm². In some embodiments, the sealed perimeter formed on the microscope slide by the gasket has an area of less than about 10 cm², such as less than about any of 9.5 cm², 9 cm², 8.5 cm², 8 cm², 7.5 cm², 7 cm², 6.5 cm², 6 cm², 5.5 cm², 5 cm², 4.5 cm², 4 cm², 3.5 cm², 3 cm², 2.5 cm², 2 cm², 1.5 cm², or 1 cm². In some embodiments, the sealed perimeter formed on the microscope slide by the gasket has an area of about any of 1 cm², 1.5 cm², 2 cm², 2.5 cm², 3 cm², 3.5 cm², 4 cm², 4.5 cm², 5 cm², 5.5 cm², 6 cm², 6.5 cm², 7 cm², 7.5 cm², 8 cm², 8.5 cm², 9 cm², 9.5 cm², or 10 cm².

In some embodiments, the material of the gasket provides a seal, such as a liquid-tight seal, between the microscope slide and the microscope slide cartridge. In some embodiments, the gasket is a resilient material over-molded to the microscope slide cartridge. In some embodiments, the gasket comprises a polished material, such as a polished polymer or metal surface. In some embodiments, the gasket comprises a polymer, such as a polymer compatible with injection molding. In some embodiments, the gasket is a plastic gasket. In some embodiments, the gasket is a rubber gasket. In some embodiments, the gasket comprises a material, wherein the material is selected based on compatibility with a material in a microscope slide. In some embodiments, the gasket comprises a material, wherein the material is selected based on compatibility with a fluid, such as a reagent or buffer.

In some embodiments, the microscope slide cartridge is configured to form a chamber (such as an enclosed or an open-air chamber) having a volume capacity to hold an amount of a fluid. It will be readily recognized that the volume of the chamber is controlled by the area formed on a microscope slide by the gasket, the height of at least one of the one or more walls, and/or the design of the inclined waste flow pathway. In some embodiments, the chamber has a volume of about 150 μL to about 5 mL. In some embodiments, the chamber has a volume of at least about 150 μL, such as at least about any of 200 μL, 250 μL, 300 μL, 350 μL, 400 μL, 450 μL, 500 μL, 550 μL, 600 μL, 650 μL, 700 μL, 750 μL, 800 μL, 850 μL, 900 μL, 950 μL, 1 mL, 1.25 mL, 1.5 mL, 1.75 mL, 2 mL, 2.25 mL, 2.5 mL, 2.75 mL, 3 mL, 3.25 mL, 3.5 mL, 3.75 mL, 4 mL, 4.25 mL, 4.5 mL, 4.75 mL, or 5 mL. In some embodiments, the chamber has a volume of about any of 150 μL, 200 μL, 250 μL, 300 μL, 350 μL, 400 μL, 450 μL, 500 μL, 550 μL, 600 μL, 650 μL, 700 μL, 750 μL, 800 μL, 850 μL, 900 μL, 950 μL, 1 mL, 1.25 mL, 1.5 mL, 1.75 mL, 2 mL, 2.25 mL, 2.5 mL, 2.75 mL, 3 mL, 3.25 mL, 3.5 mL, 3.75 mL, 4 mL, 4.25 mL, 4.5 mL, 4.75 mL, or 5 mL.

In some embodiments, the microscope slide cartridge comprises one or more clips configured to hold the face of the microscope slide against the gasket. In some embodiments, the microscope slide cartridge comprises two clips configured to hold the face of the microscope slide against the gasket, wherein the two clips are positioned to engage opposite sides of the microscope slide. In some embodiments, the microscope slide is held against the gasket of the microscope slide cartridge with enough force to create a seal that resists fluid from leaving the chamber formed over the face of the microscope slide. In some embodiments, the one or more clips configured to hold the face of the microscope slide against the gasket are configured to be depressible such that a microscope slide can be loaded and/or unloaded into a microscope slide cartridge. In some embodiments, the one or more clips comprises a ledge that interfaces with the microscope slide face that is opposite of the microscope slide face with a tissue sample thereon.

In some embodiments, the microscope slide cartridge comprises a portion of a locking clip. In some embodiments, the portion of the locking clip of the microscope slide cartridge is configured to interface with another portion of the locking clip located on a microscope slide cartridge stall. In some embodiments, the locking clip is positioned on the distal portion of the microscope slide cartridge, wherein the distal portion is the portion of the microscope slide cartridge assembly that is farthest from the first axis of rotation when the microscope slide cartridge assembly is loaded in a microscope slide cartridge stall. In some embodiments, the locking clip is configured to align the microscope slide cartridge assembly in a pre-determined position, e.g., such that the fluid input port is aligned to receive fluid from the reagent carousel.

In some embodiments, the microscope slide cartridge comprises an inclined waste flow pathway configured to direct fluid flow from the chamber to a waste output element. In some embodiments, features of the incline are based on the rotational speed of the microscope slide carousel. For example, in some embodiments, one or more of the slope, height, and width of the inclined waste flow pathway are designed such that a volume of fluid will be held in the chamber during certain relatively lower rotational speeds of the microscope slide carousel and that the volume of fluid will be evacuated from the chamber during certain relatively higher rotational speeds. In some embodiments, another portions of the microscope slide cartridge may be designed to facilitate the flow of fluid in the chamber to the inclined waste flow pathway, such as an angled wall located near the distal portion of the microscope slide cartridge. In some embodiments, the inclined waste flow pathway is in fluidic communication with a waste reservoir.

In some embodiments, the microscope slide cartridge assembly comprises a microscope slide covertile. In some embodiments, the microscope slide covertile is configured to be positioned over a microscope slide thereby forming a space over the microscope slide. In some embodiments, the microscope slide covertile is configured to be positioned over a tissue sample on a microscope slide thereby forming a space over the microscope slide that covers the tissue sample. In some embodiments, the microscope slide covertile is configured to provide a low-volume space over a tissue sample on a microscope slide, wherein the space can hold an amount of a solution, e.g., a reagent, during certain aspects of the operation of the device when a tissue sample is present. In some embodiments, the space is configured to allow a minimal amount of fluid to be used to cover the entire tissue sample under the covertile with the aid of surface tension and/or capillary actions within the space formed by the microscope slide covertile. In some embodiments, the microscope slide covertile is configured to allow for a fluid to be removed from the space when a force is exerted on the microscope slide cartridge assembly during operation of a device described herein, e.g., centrifugation. In some embodiments, the space formed by the microscope slide covertile is configured to hold an amount of a solution of between about 40 μL to about 500 μL, such between any of about 50 μL to about 175 μL, about 75 μL to about 150 μL, about 100 μL to about 150 μL, about 100 μL to about 125 μL, about 100 μL to about 300 μL, or about 250 μL to about 500 μL. In some embodiments, the chamber formed by the microscope slide covertile is configured to hold an amount of a solution of about 500 μL or less, such as about any of 450 μL or less, 400 μL or less, 350 μL or less, 300 μL or less, 250 μL or less, 200 μL or less, 190 μL or less, 180 μL or less, 170 μL or less, 160 μL or less, 150 μL or less, 140 μL or less, 130 μL or less, 120 μL or less, 110 μL or less, 100 μL or less, 90 μL or less, 80 μL or less, 70 μL or less, 60 μL or less, 50 μL or less, or 40 μL or less. In some embodiments, the chamber formed by the microscope slide covertile is configured to hold an amount of a solution of about any of 40 μL, 50 μL, 60 μL, 70 μL, 80 μL, 90 μL, 100 μL, 110 μL, 120 μL, 130 μL, 140 μL, 150 μL, 160 μL, 170 μL, 180 μL, 190 μL, 200 μL, 250 μL, 300 μL, 350 μL, 400 μL, 450 μL, or 500 μL. In some embodiments, the top surface (based on the surface of the microscope slide covertile facing the microscope slide) of the space formed by the microscope slide covertile over the microscope slide has a height of between about 5 mm to about 0.1 mm, such as between about 2 mm to about 0.2 mm. In some embodiments, the top surface (based on the surface of the microscope slide covertile facing the microscope slide) of the space formed by the microscope slide covertile over the microscope slide has a height of about 5 mm or less, such as about any of 4.5 mm or less, 4 mm or less, 3.5 mm or less, 3 mm or less, 2.5 mm or less, 2 mm or less, 1.5 mm or less, or 1 mm or less. In some embodiments, the microscope slide covertile comprises one or more features that interface with a microscope slide thereby forming a space over the microscope slide. In some embodiments, the microscope slide covertile comprises downward protruding spacers at, or near, the perimeter of the microscope slide covertile, wherein the spacers form a narrow space between the microscope slide covertile and the microscope slide. In some embodiments, the microscope slide covertile comprises one or more downward protruding spacers, such as any of two or more or three or more. In some embodiments, the microscope slide covertile comprises any of 2, 3, 4, 5, or 6 downward protruding spacers. The downward producing spacers may be any shape, and in some embodiments are configured to avoid contact with the placement of a sample on a microscope slide and/or to avoid impeding fluid flow. In some embodiments, the height of the downward protruding spacer is about 0.05 mm to about 5 mm, such as any of 0.1 mm to about 2.5 mm or 0.14 mm to about 0.2 mm. In some embodiments, the height of the downward protruding spacer is about 0.5 mm or less, such as about any of 0.45 mm or less, 0.4 mm or less, 0.35 mm or less, 0.3 mm or less, 0.25 mm or less, 0.2 mm or less, 0.15 mm or less, or 0.1 mm or less. In some embodiments, the proximal portion of the microscope slide covertile is configured such that a solution, such as a reagent, can flow from the fluid inlet port of the microscope slide cartridge to a tissue sample on the microscope slide. In some embodiments, the distal portion of the microscope slide covertile is configured such that a solution, such as a reagent, can flow from the space under the microscope slide covertile to the waste reservoir, such as via an inclined waste flow pathway of the microscope slide cartridge assembly. In some embodiments, the microscope slide covertile is configured to be compatible with, such as interface with, a microscope slide cartridge. In some embodiments, the microscope slide covertile is fine polished at optical grade to allow direct inspection of the stained slides during use, such as immediately after staining and/or mounting. In some embodiments, the surface of the microscope slide covertile that faces the microscope slide comprises a substantially flat portion. In some embodiments, the microscope slide covertile is configured to be buoyant, such that when large volumes of a fluid (such as greater than the volume of the space formed over the microscope slide; e.g., up to about 2000-3000 μL) are applied to the microscope slide the microscope slide covertile stays on top of the fluid.

iii. Other Components of, or Associated with, the Microscope Slide Carousel

The microscope slide carousels described herein comprises a first rotary control mechanism configured to control the rotation of the microscope slide carousels. In some embodiments, the first rotary control mechanism comprises a first rotary actuator. In some embodiments, the first rotary actuator is a rotary stepper motor. In some embodiments, the first rotary control mechanism is configured to rotate the microscope slide carousel at least 360° on the first axis of rotation. In some embodiments, the first rotary control mechanism is configured to rotate the microscope slide carousel clockwise or counterclockwise. In some embodiments, the first rotary control mechanism is configured to rotate the microscope slide carousel at variable rotation speeds. In some embodiments, the first rotary control mechanism is configured to rotate the microscope slide carousel to position the microscope slide carousel to a pre-determined orientation relative to an aspect of the reagent assembly, such as the port of the reagent assembly. In some embodiments, the first rotary control mechanism is configured to rotate the microscope slide carousel on the first axis of rotation at a speed sufficient to distribute, such as substantially evenly distribute, a reagent over a tissue sample. In some embodiments, the first rotary control mechanism is configured to rotate the microscope slide carousel on the first axis of rotation at a speed sufficient to mix two or more fluids in the chamber of a microscope slide cartridge assembly. In some embodiments, the first rotary control mechanism is configured to rotate the microscope slide carousel on the first axis of rotation at a speed sufficient to remove a fluid, such as a reagent or a wash buffer, from the chamber of a microscope slide cartridge assembly.

In some embodiments, the microscope slide carousel is configured to rotate on the first axis of rotation in any direction, such as clockwise and counterclockwise. In some embodiments, the microscope slide carousel is configured to rotate on the first axis of rotation both clockwise and counterclockwise. In some embodiments, the microscope slide carousel is configured to rotate on the first axis of rotation at variable rotation speeds. In some embodiments, the microscope slide carousel is configured to rotate on the first axis of rotation at a speed sufficient to distribute, such as substantially evenly distribute, a reagent over a tissue sample. In some embodiments, the microscope slide carousel is configured to rotate on the first axis of rotation at a speed sufficient to mix two or more fluids in the chamber of a microscope slide cartridge assembly. In some embodiments, the microscope slide carousel is configured to rotate on the first axis of rotation at a speed sufficient to remove a fluid, such as a reagent or a wash buffer, from the chamber of a microscope slide cartridge assembly.

In some embodiments, the first rotary control mechanism is configured to be in communication with a control unit. In some embodiments, the first rotary control mechanism is a digitally controlled rotary control mechanism.

In some embodiments, the microscope slide carousel further comprises a microscope slide carousel waste reservoir. In some embodiments, the microscope slide carousel waste reservoir is in fluid communication with each microscope slide cartridge stall. In some embodiments, the microscope slide carousel waste reservoir is in fluid communication with each microscope slide cartridge stall via the inclined waste flow pathway of the microscope slide cartridge. In some embodiments, the microscope slide carousel waste reservoir is in fluid communication with the chamber of a microscope slide cartridge assembly via the inclined waste flow pathway of the microscope slide cartridge.

In some embodiments, the microscope slide carousel waste reservoir further comprises a waste removal outlet. In some embodiments, the waste removal outlet is in fluid communication with a waste reservoir.

In some embodiments, the microscope slide carousel further comprises at least one pre-wash inlet. In some embodiments, the pre-wash inlet is positioned such that there is a fluid path from the reagent carousel to the pre-wash inlet. Such features are useful for, e.g., purging and/or priming a fluid, such as air, reagent, or buffer, prior to directing the flow of the fluid to the microscope slide cartridge assembly. In some embodiments, the pre-wash inlet, or a similar port, is in fluid communication with the microscope slide carousel waste reservoir.

In some embodiments, the microscope slide carousel further comprises a heating element. In some embodiments, the heating element is used to control the temperature of a tissue sample on a microscope slide, or the surrounding area. Thus, in some embodiments, the heating element is positioned in proximity to the microscope slide of the microscope slide cartridge assembly. In some embodiments, the heating element is position under the microscope slide cartridge stall. In some embodiments, the tissue staining devices described herein comprise a microscope slide carousel comprising a single heating element. In some embodiments, the tissue staining devices described herein comprise a microscope slide carousel comprising two or more heating elements. In some embodiments, the heating element is a heat block. In some embodiments, the heating element is configured to maintain a microscope slide, or the surrounding area, at a desired temperature, such as required for a tissue processing protocol. In some embodiments, the desired temperature is about 10° C. to about 60° C. In some embodiments, the desired temperature is at least about 10° C., such as at least about any of 15° C., 20° C., 25° C., 30° C., 35° C., 40° C., 50° C., 55° C., or 60° C. In some embodiments, the desired temperature is about any of 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., or 60° C. In some embodiments, the heating element is configured to be in communication with a control unit.

In some embodiments, the tissue staining devices described herein further comprise a cooling element, such as a Peltier cooler. In some embodiments, the cooling element is configured to be in communication with a control unit.

In some embodiments, the microscope slide carousel further comprises a temperature sensing element. In some embodiments, the temperature sensing element is used to measure and/or monitor the temperature of a tissue sample on a microscope slide, or the surrounding area. Thus, in some embodiments, the temperature sensing element is positioned in proximity to the microscope slide of the microscope slide cartridge assembly. In some embodiments, the temperature sensing element is position under the microscope slide cartridge stall. In some embodiments, the tissue staining devices described herein comprise a microscope slide carousel comprising a single temperature sensing element. In some embodiments, the tissue staining devices described herein comprise a microscope slide carousel comprising a temperature sensing element for each microscope slide cartridge stall. In some embodiments, the temperature sensing element is configured to be in communication with a control unit.

### B. Reagent Assembly

The devices described herein comprise a reagent assembly comprising: (i) a reagent carousel, wherein the reagent carousel comprises at least one reagent holder, and (ii) a dispensing actuator, wherein the reagent carousel is positioned above the microscope slide carousel, and wherein the reagent carousel and the microscope slide carousel are positioned such that when a reagent is placed in the reagent carousel the reagent can flow from the reagent carousel to the microscope slide carousel. In some embodiments, the reagent carousel is configured to rotate on a second axis of rotation.

i. Reagent Carousels

The reagent carousel described herein may be designed, at least in part, with a range of the number of reagent holders. In some embodiments, the reagent carousel comprises between about 2 reagent holders and about 20 reagent holders, such as any of about 5 reagent holders to about 20 reagent holders, about 5 reagent holders to about 10 reagent holders, or about 10 reagent holders to about 20 reagent holders. In some embodiments, the reagent carousel comprises at least about 2, such as at least about any of 3, 4, 5, 6, 7, 8, 9, 10, 11, 12, 13, 14, 15, 16, 17, 18, 19, or 20, reagent holders. In some embodiments, the reagent carousel comprises any of 2 reagent holders, 3 reagent holders, 4 reagent holders, 5 reagent holders, 6 reagent holders, 7 reagent holders, 8 reagent holders, 9 reagent holders, 10 reagent holders, 11 reagent holders, 12 reagent holders, 13 reagent holders, 14 reagent holders, 15 reagent holders, 16 reagent holders, 17 reagent holders, 18 reagent holders, 19 reagent holders, or 20 reagent holders. In some embodiments, the reagent holders of a single reagent carousel are configured to hold reagent bottles of different sizes and/or shapes.

In some embodiments, each reagent holder is configured to hold a reagent bottle in a pre-determined orientation. In some embodiments, the reagent holder comprises a depression to accept the reagent bottle in the pre-specified orientation. In some embodiments, the reagent holder comprises a portion of a locking clip configured to hold a reagent bottle in a pre-determined position.

In some embodiments, the tissue staining devices described herein further comprise one or more reagent bottles. In some embodiments, the reagent bottle is designed to dispense, such as consistently dispense, a pre-determined amount of a fluid, such as a reagent (e.g., immuno-reagent or a chemical stain), with minimal dead volume loss. In some embodiments, the reagent bottle comprises: (a) a reagent reservoir; (b) a mounting element; and (c) a dispensing element, wherein the dispensing element comprises a press-to-dispense assembly and a reagent outlet.

In some embodiments, the press-to-dispense assembly is configured to dispense about 50 μL to about 200 μL, such as any of about 50 μL to about 100 μL, about 75 μL to about 125 μL, about 100 μL to about 150 μL, about 125 μL to about 175 μL, or about 150 μL to about 200 μL, per complete press. In some embodiments, the press-to-dispense assembly is configured to dispense at least about 50 μL, such as at least about any of 75 μL, 100 μL, 125 μL, 150 μL, 175 μL, 200 μL, per complete press. In some embodiments, the press-to-dispense assembly is configured to dispense less than about 200 μL, such as less than about any of 175 μL, 150 μL, 125 μL, 100 μL, 75 μL, or 50 μL, per complete press. In some embodiments, the press-to-dispense assembly is configured to dispense about any of 50 μL, 60 μL, 70 μL, 80 μL, 90 μL, 100 μL, 110 μL, 120 μL, 130 μL, 140 μL, 150 μL, 160 μL, 170 μL, 180 μL, 190 μL, or 200 μL per complete press. In some embodiments, the dispensed volume can be controlled based on the degree to which the press-to-dispense assembly is depressed. In some embodiments, the tissue staining device described herein is configured to dispense a volume of a reagent from a reagent bottle, wherein the volume is about any of 50 μL, 60 μL, 70 μL, 80 μL, 90 μL, 100 μL, 110 μL, 120 μL, 130 μL, 140 μL, 150 μL, 160 μL, 170 μL, 180 μL, 190 μL, or 200 μL.

In some embodiments, the reagent reservoir has a volume of about 5 mL to about 30 mL. In some embodiments, the reagent reservoir has a volume of at least about 5 mL, such as at least about any of 10 mL, 15 mL, 20 mL, 25 mL, or 30 mL. In some embodiments, the reagent reservoir has a volume of less than about 30 mL, such as less than about any of 25 mL, 20 mL, 15 mL, 10 mL, or 5 mL. In some embodiments, the reagent reservoir has a volume of about any of 5 mL, 10 mL, 15 mL, 20 mL, 25 mL, or 30 mL. In some embodiments, a mounting element may accommodate more than one size of reagent bottle, wherein the different sized reagent bottles have reagent reservoirs with different volumes.

In some embodiments, the reagent bottle further comprise one portion of a locking clip. In some embodiments, the one portion of the locking clip of the reagent bottle is positioned on the mounting element. In some embodiments, the portion of the locking clip of the reagent bottle is configured to interface with the portion of the locking clip on the reagent holder.

In some embodiments, the reagent bottle further comprises a label, e.g., containing identifying information, such as the reagent contained therein, available reagent volume, and information about the reagent bottle, including size, dispensing volume, and positioning. In some embodiments, the label is a barcode label. In some embodiments, the label, such as the barcode label, is positioned on the mounting element.

In some embodiments, the reagent assembly further comprises a second rotary control mechanism configured to control the rotation of the reagent carousel. In some embodiments, the second rotary control mechanism comprises a stationary actuator positioned relative to the first axis of rotation. In some embodiments, the second rotary control mechanism is a rotary stepper motor. In some embodiments, the second rotary control mechanism is configured to rotate the reagent carousel at least 360° on the second axis of rotation. In some embodiments, the second rotary control mechanism is configured to rotate the reagent carousel clockwise or counterclockwise. In some embodiments, the second rotary control mechanism is configured to rotate the reagent carousel to position the reagent carousel to a pre-determined orientation relative to an aspect of the microscope slide carousel or the reagent assembly, such as the port of the reagent assembly.

In some embodiments, the reagent carousel is configured to rotate on the second axis of rotation in any direction, such as clockwise and counterclockwise. In some embodiments, the reagent carousel is configured to rotate on the second axis of rotation both clockwise and counterclockwise. In some embodiments, the second rotary control mechanism is configured to be in communication with a control unit.

In some embodiments, the reagent assembly comprises at least one common liquid dispenser comprising a liquid dispenser output port and at least one liquid pump. In some embodiments, the common liquid dispenser dispenses a buffer. In some embodiments, the buffer is held in a buffer reservoir, such as stored in a bulk solution rack. In some embodiments, the liquid dispenser output port is in fluid communication with the buffer reservoir. In some embodiments, the liquid pump is configured to be in communication with a control unit. In some embodiments, the liquid pump is a peristaltic pump. In some embodiments, the liquid pump is a diaphragm pump.

In some embodiments, the liquid dispenser output port is positioned such that when a liquid is dispensed from the liquid dispenser output port the liquid can flow from the liquid dispenser output port to the input port of the microscope slide cartridge assembly on the microscope slide carousel. In some embodiments, the directionality of the flow of the liquid is based on gravitational force. In some embodiments, the liquid flow represents an imaginary second liquid dispensing axis. In some embodiments, the second liquid dispensing axis and the first axis of rotation and/or the second axis of rotation and/or the first axis of rotation are substantially parallel.

ii. Dispensing Actuator

The dispensing actuators described herein may be configured to mechanically control dispensing of a fluid from a reagent bottle using depression of the reagent bottle on a reagent carousel.

In some embodiments, the dispensing actuator comprises a central body coupled to a dispensing arm, wherein the dispensing actuator comprises an arm movement mechanism configured to move the dispensing arm in a direction substantially parallel with the reagent dispensing axis. In some embodiments, the arm movement mechanism is a linear actuator. In some embodiments, the dispensing actuator is configured to be in communication with a control unit.

In some embodiments, the dispensing arm extends from the central body of the dispensing actuator to over at least a portion of the reagent carousel. In some embodiments, the dispensing arm extends from the central body of the dispensing actuator to over at least a portion of each reagent holder. In some embodiments, the dispensing arm extends from the central body of the dispensing actuator to over the base of a reagent bottle, such that when the dispensing actuator arm movement mechanisms is activated the dispensing arm will push down the reagent bottle to dispense a reagent therein.

In some embodiments, the arm movement mechanism is configured to move the dispensing arm at least about 0.2 inches, such as at least about 0.4 inches, 0.6 inches, 0.8 inches, 1 inches, 1.2 inches, 1.4 inches, 1.6 inches, 1.8 inches, 2 inches, 2.5 inches, or 3 inches.

In some embodiments, the dispensing actuator does not rotate on an axis of rotation, such as the second axis of rotation.

### C. Other Device Features and Elements

In addition to the features disclosed in other sections, the devices described herein may comprise one or more additional elements that facilitate any aspect of the use and/or operation of such devices.

In some embodiments, to ensure proper fluid dispensing, the tissue staining device comprises one or more detectors and/or cameras configured to detect the presence, or absence, of one or more labels on a components of the devices described herein, e.g., a microscope slide, a microscope slide cartridge stall, a reagent bottle, or a buffer reservoir. In some embodiments, the tissue staining device further comprises a detector configured to image and read a barcode label. In some embodiments, the tissue staining device further comprises a camera configured to image and read a barcode label. There are a wide range of detectors and/or cameras, and corresponding labels, known in the art that are useful for the tissue staining devices disclosed herein. In some embodiments, the detector is a visual detector. In some embodiments, the detector is a camera. In some embodiments, the detector is a RFID detector. In some embodiment, the detector comprises a barcode reader. In some embodiments, the detector and/or camera is configured to be in communication with a control unit. In some embodiments, the detector is a digitally controlled detector.

In some embodiments, the detector is configured to facilitate automation of a tissue processing protocol. For example, in some embodiments, to ensure proper execution of a tissue staining protocol, upon placement of a microscope slide cartridge assembly in a microscope slide cartridge stall, the tissue staining device comprises a detector configured to detect one or more labels, thereby initiating and executing the desired tissue staining protocol.

In some embodiments, the tissue staining device comprises a detector, such as a barcode reader, digital camera, or sensor, wherein the detector is positioned with a field of view of at least a portion of one or more elements of the tissue staining device or an object placed therein, such as a microscope slide cartridge assembly or a reagent bottle.

In some embodiments, the tissue staining device further comprises a bulk solution rack. In some embodiments, the bulk solution rack is mounted on pull-out drawer slides. In some embodiments, the bulk solution rack is positioned below the microscope slide carousel. In some embodiments, the bulk solution rack comprises one or more buffer reservoirs, such as for storage of fluids used during a tissue processing protocol, e.g., a wash, water, a buffer, a blocking agent, ethanol, or a dehydrating agent. In some embodiments, the buffer reservoir comprises an alignment notch. In some embodiments, the alignment notch is configured to align a buffer reservoir in a desired position. In some embodiments, the alignment notch is configured to interface with a corresponding feature on the bulk solution rack.

In some embodiments, the tissue staining device further comprises a waste receptacle. In some embodiments, the waste receptacle is fluidically connected to the waste removal outlet of the microscope slide carousel. In some embodiments, the waste receptacle is position on the bulk solution rack. In some embodiments, the waste receptacle is positioned on a waste receptacle storage rack. In some embodiments, the waste receptacle storage rack is mounted on pull-out drawer slides. In some embodiments, the waste receptacle storage rack is positioned below the microscope slide carousel. In some embodiments, the waste receptacle storage rack is positioned adjacent to the bulk solution rack.

In some embodiments, the tissue staining device further comprises one or more liquid pumps connected with tubing. In some embodiments, the one or more liquid pumps are configured to deliver fluid, such as a reagent or a wash buffer, from a container positioned on a bulk solution rack to a component of the tissue staining device that enables delivery of the fluid to a tissue sample on a microscope slide. In some embodiments, the one or more liquid pumps are configured to be in communication with a control unit. In some embodiments, the liquid pump is a peristaltic pump. In some embodiments, the liquid pump is a diaphragm pump.

In some embodiments, the device described herein further comprises a flow detector. In some embodiments, the flow detector is configured to detect flow of a fluid from one location to another. In some embodiments, the flow detector is configured to detect flow of a fluid from the reagent carousel to a microscope slide cartridge assembly. In some embodiments, the flow detector is configured to detect flow of a fluid from a common fluid dispenser to a microscope slide cartridge assembly. In some embodiments, the flow detector is configured to be in communication with a control unit.

In some embodiments, the device described herein further comprises a control unit. In some embodiments, the control unit is configured to control, such as to provide instructions to and/or operate one or more elements of a tissue staining device. In some embodiments, the control unit is configured to receive information, such as temperature measurements or positional information, from one or more elements of a tissue staining device. In some embodiments, the control unit comprises a computer. In some embodiments, the control unit comprises a communication interface component, such as to connect a tissue staining device to an external computer or a part thereof.

In some embodiments, the control unit is operably connected to any, such as all, features of a tissue staining device capable of receiving instructions to perform a function. In some embodiments, the control unit is coupled to one or more elements, or a component thereof, selected from any one or more of a microscope slide carousel, a first rotary control mechanism, a reagent assembly, a reagent carousel, a second rotary control mechanism, a dispensing actuator, a fluid pump, a heating element, a temperature sensing element, and a detector.

In some embodiments, the control unit comprises one or more processors and memory storing one or more programs, the one or more programs configured to be executed by the one or more processors, the one or more programs including instructions for: (i) positioning and/or rotating a microscope slide carousel; (ii) positioning a reagent carousel body; (iii) positioning a dispensing actuator; (iv) dispensing a fluid; (v) operating a detector; (vi) controlling the temperature of a microscope slide stall; (vii) sensing a temperature; (viii) performing a tissue processing protocol; an (ix) performing a tissue dehydration protocol.

In some embodiments, the tissue staining device further comprises a user interface component. In some embodiments, the user interface comprises a screen displaying a message to the user. In some embodiments, the user interface comprises a feature to accept user input, such as a keyboard or a touch screen.

### III. Exemplary Devices and Components Thereof

Figures of exemplary devices, and components thereof, are provided to facilitate the understanding and operational aspects of the devices of the present application, including the integration of components thereof. Such exemplary descriptions are not to be interpreted as limiting the devices described herein.

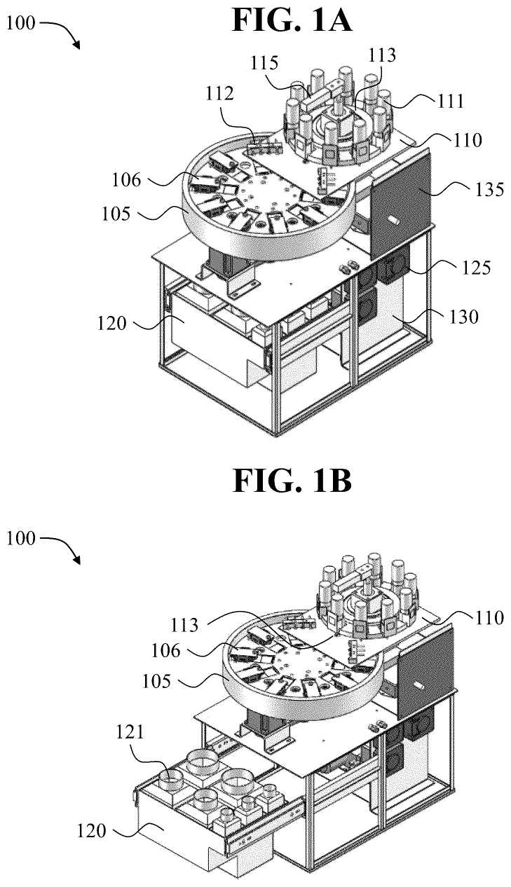

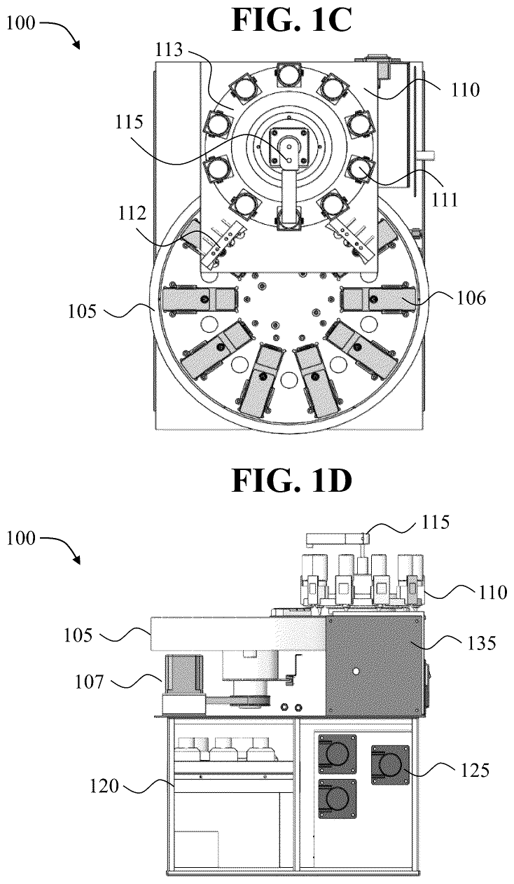

FIGS. 1A-1D show select views of a 3D model of an exemplary tissue staining device 100. As shown in FIG. 1A, the exemplary tissue staining device 100 comprises the integration of many components, including: (a) a microscope slide carousel 105, wherein the microscope slide carousel comprises at least one microscope slide cartridge stall 106; (b) a reagent assembly 110 comprising: (i) a reagent carousel 113, (ii) a dispensing actuator 115; (c) a bulk solution rack 120; (d) liquid pumps 125; (e) a waste receptacle 130; and (f) a control unit 135. The exemplary tissue staining device 100 shown in FIG. 1A has a reagent assembly loaded with a plurality of reagent bottles, e.g., 111 (which are held in place via reagent holders), and two common liquid dispensers 112.

As shown in FIG. 1B, the microscope slide carousel 105 and the reagent assembly 110 are positioned such that a port 113 in the reagent assembly 110 enables the flow of reagents to the microscope slide cartridge assemblies 106. The bulk solution rack 120 of the exemplary tissue staining device 100 is designed to hold a variety of buffer reservoirs, e.g., 121, and to slide out on pull-out drawer slides to provide easy accessibility.

A top view of the exemplary tissue staining device 100 is shown in FIG. 1C to further illustrate the relative positioning of the microscope slide carousel 105 and the reagent assembly 110.

A side view of the exemplary tissue staining device 100 is shown in FIG. 1D to further illustrate the relative positioning of the microscope slide carousel 105 and the reagent assembly 110. Additionally, this view illustrates the positioning of the first rotary control mechanism 107 comprising a first rotary actuator.

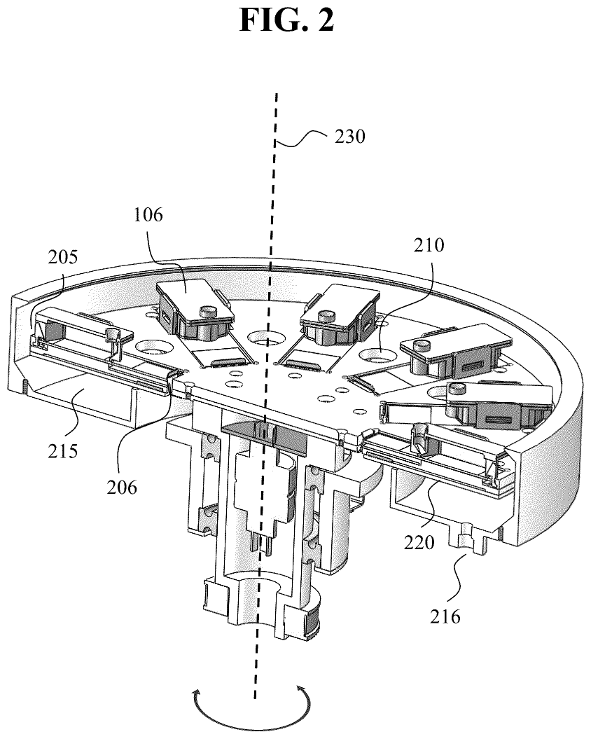

FIG. 2 shows a cross-sectional view of a 3D model of aspects of an exemplary microscope slide carousel. As shown in FIG. 2, the microscope slide cartridge assemblies 106 are held in place via a cartridge lock 205 and a loading spring 206. The exemplary microscope slide carousel comprises ports, e.g., a pre-wash inlet 210, useful for purging fluids to the waste chamber 215. Fluid collected in the waste chamber 215 may flow to a waste reservoir via the waste port 216. The exemplary microscope slide carousel of FIG. 2 comprises a heating element 220 and a temperature sensing element. The microscope slide carousel is configured to rotate on a first axis of rotation represented by the dashed line 230.

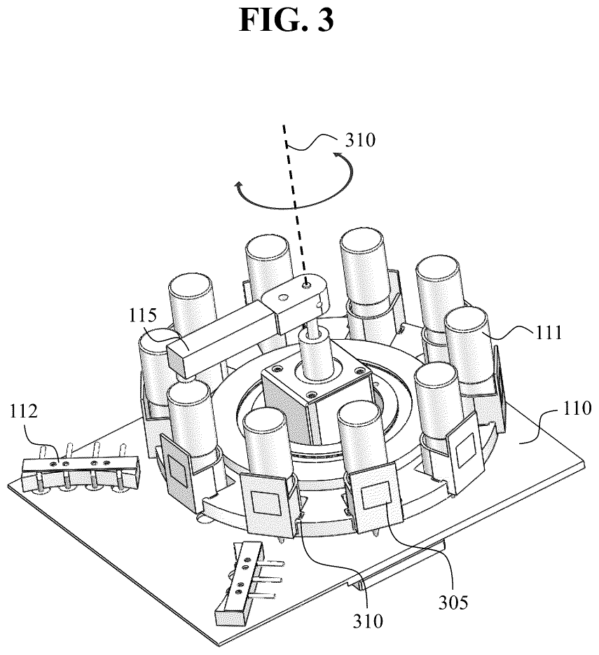

FIG. 3 shows a view of a 3D model of aspects of an exemplary reagent assembly. In addition to the components shown in previous figures, the reagent holders of the reagent carousel comprise a depression to accept and lock the reagent bottle in the pre-specified orientation 310. The exemplary reagent assembly is configured to rotate on a second axis of rotation represented by the dashed line 310.

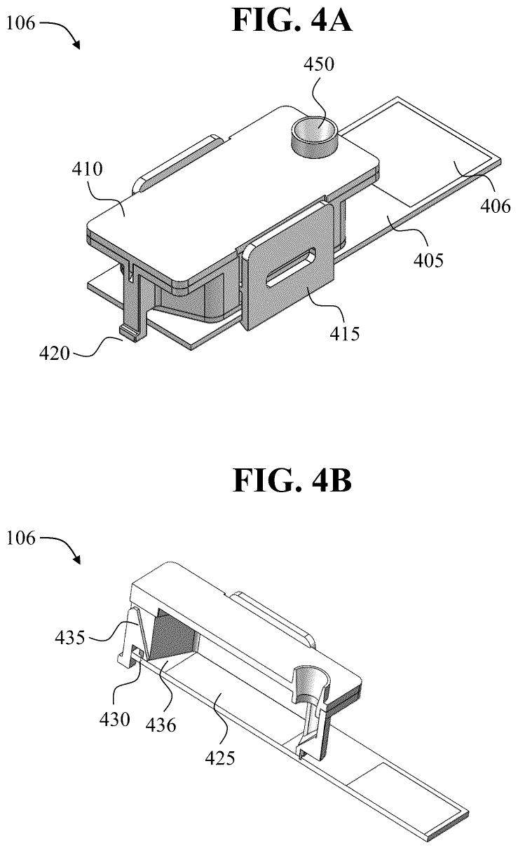

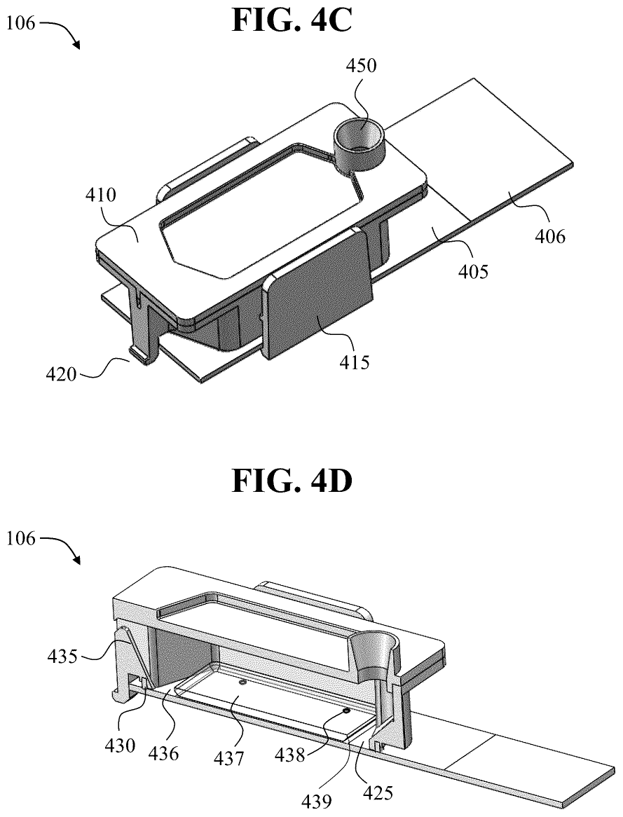

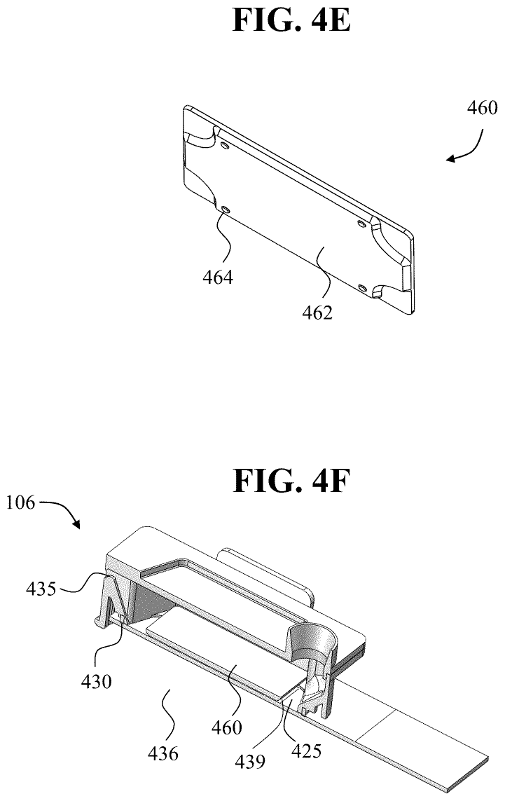

FIG. 4A shows a view of a 3D model of an exemplary microscope slide cartridge assembly 106. As illustrated therein, the microscope slide cartridge 410 interfaces with a microscope slide 405 to form the microscope slide cartridge assembly 106. The microscope slide cartridge comprises a fluid input port 450 that is configured for delivery of fluid to a tissue sample on the microscope slide. The clip 415 on the microscope slide cartridge 410 is configured to hold the microscope slide cartridge against the face of the microscope slide 405 such that the gasket (not pictured) of the microscope slide cartridge creates a seal around an area of the microscope slide 405. The clip 415 can also be used to release the microscope slide 405 from the microscope slide cartridge 410. In some embodiments, the microscope slide cartridge comprises two or more clips. Also as shown in FIG. 4A, the microscope slide cartridge comprises a portion of a locking clip 420 that interface with another portion of the locking clip located on a microscope slide cartridge stall such that the microscope slide cartridge assembly 106 is held in place during operation of the device. In some embodiments, the microscope slide 405 comprises a label 406, which may contain, e.g., identifying information regarding the tissue sample thereon.

FIG. 4B shows a cross-sectional view of a 3D model of aspects of an exemplary microscope slide cartridge assembly 106. The cross-sectional view provides an illustration of the chamber that is formed over an area 425 on the microscope slide. The microscope slide cartridge comprises a gasket 430 that creates a seal around an area 425 of the microscope slide. The microscope slide cartridge also comprises an inclined waste flow pathway 435 configured to direct fluid flow from the chamber to a waste output element. Additionally, other portions of the microscope slide cartridge may be designed to facilitate the flow of fluid to the inclined waste flow pathway 435, such as the angled back wall 436.

FIG. 4C shows a view of a 3D model of an exemplary microscope slide cartridge assembly 106. As illustrated therein, the microscope slide cartridge 410 interfaces with a microscope slide 405 to form the microscope slide cartridge assembly 106. The microscope slide cartridge comprises a fluid input port 450 that is configured for delivery of fluid to a tissue sample on the microscope slide. The clip 415 on the microscope slide cartridge 410 is configured to hold the microscope slide cartridge against the face of the microscope slide 405 such that the gasket (not pictured) of the microscope slide cartridge creates a seal around an area of the microscope slide 405. The clip 415 can also be used to release the microscope slide 405 from the microscope slide cartridge 410. In some embodiments, the microscope slide cartridge comprises two or more clips. Also as shown in FIG. 4C, the microscope slide cartridge comprises a portion of a locking clip 420 that interface with another portion of the locking clip located on a microscope slide cartridge stall such that the microscope slide cartridge assembly 106 is held in place during operation of the device. In some embodiments, the microscope slide 405 comprises a label 406, which may contain, e.g., identifying information regarding the tissue sample thereon.

FIG. 4D shows a cross-sectional view of a 3D model of aspects of an exemplary microscope slide cartridge assembly 106. The cross-sectional view provides an illustration of the chamber that is formed over an area 425 on the microscope slide. The microscope slide cartridge comprises a gasket 430 that creates a seal around an area 425 of the microscope slide. A polished microscope slide covertile 437 is also placed on the microscope slide and fits within the chamber formed by the microscope slide cartridge. The microscope slide covertile 437 comprises downwardly protruding spacers at its perimeter 438 to make a thin space 439 between the microscope slide and the microscope slide covertile. The microscope slide cartridge also comprises an inclined waste flow pathway 435 configured to direct fluid flow from the chamber to a waste output element. Additionally, other portions of the microscope slide cartridge may be designed to facilitate the flow of fluid to the inclined waste flow pathway 435, such as the angled back wall 436.

FIG. 4E shows a view of a 3D model of an exemplary microscope slide covertile 460. As shown, the microscope slide covertile 460 comprises a surface that faces the microscope slide comprising a substantially flat portion 462, and four downward protruding spacers, e.g., 464. FIG. 4D shows a cross-sectional view of a 3D model of aspects of an exemplary microscope slide cartridge assembly 106 with the microscope slide cover 460. The cross-sectional view provides an illustration of the chamber that is formed over an area 425 on the microscope slide. The microscope slide cartridge comprises a gasket 430 that creates a seal around an area 425 of the microscope slide. A microscope slide covertile 460 is also placed on the microscope slide and fits within the chamber formed by the microscope slide cartridge. The microscope slide covertile 460 comprises downwardly protruding spacers that form a thin space 439 between the microscope slide and the microscope slide covertile. The microscope slide cartridge also comprises an inclined waste flow pathway 435 configured to direct fluid flow from the chamber to a waste output element.

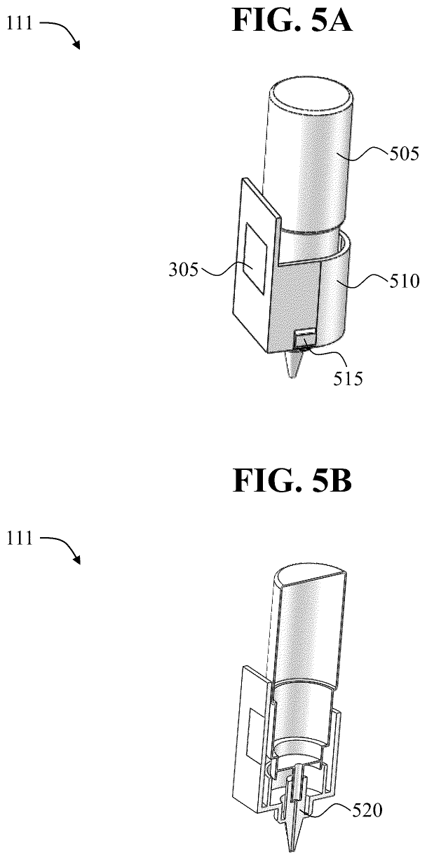

FIGS. 5A and 5B show select views, including a cross-sectional view (FIG. 5B), of a 3D model of an exemplary reagent bottle 111. As shown in FIGS. 5A and 5B, the reagent bottle comprises: (a) a reagent reservoir 505; (b) a mounting element 510; and (c) a dispensing element 520, wherein the dispensing element comprises a press-to-dispense assembly and a reagent outlet. The reagent bottle may comprise a portion of a locking clip 515 that interfaces with a reagent holder of the reagent carousel, and/or a label 305.

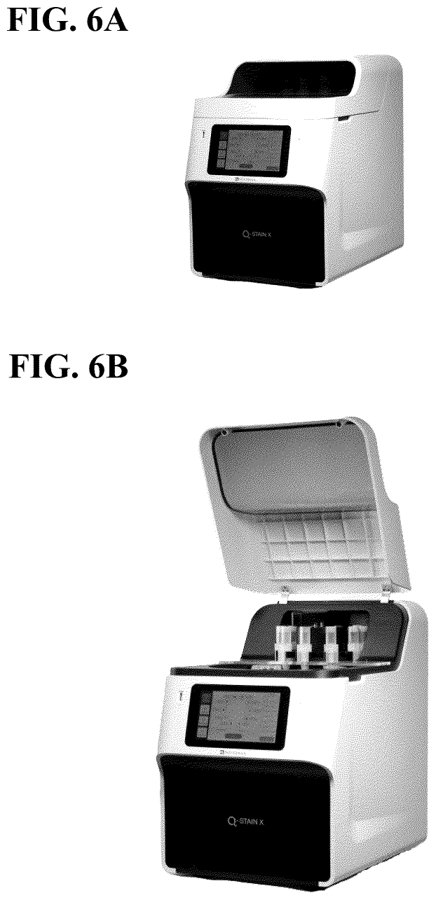

FIGS. 6A and 6B show the exterior views and features of the described tissue staining device. The graphical user interface control unit is mounted face forward with a tilted angle for convenient access by a device operator. The transparent upper lid allows continuous monitoring of device operation status. The upper lid can be opened for loading slide cartridge assembly and for loading reagents.

### IV. Methods of Use, Systems, and Kits of the Described Devices and Components Thereof

The present disclosure provides, in other aspects, methods of using the devices disclosed herein, systems comprising the devices disclosed herein, and kits comprising elements (such as components) of the devices disclosed herein.

Methods of processing tissue samples, such as chemical staining, pre-treatment, immuno-staining, tissue dehydration, and covertile mounting are known in the art. For example, direct IHC staining methods are disclosed in U.S. Patent Publication No. 20170074867, which is hereby incorporated by reference in its entirety. The tissue staining devices disclosed herein are configured to process tissue samples according to such known methods, including process a tissue sample by performing any one or more of chemical staining, pre-treatment, immuno-staining, tissue dehydration, and covertile mounting methods. In some embodiments, the method comprises processing a tissue sample via any one of more a chemical staining method, an immuno-staining method, a tissue dehydration method, and a covertile mounting method.

In some embodiments, the method comprises (a) placing a microscope slide cartridge assembly in a microscope slide stall of a tissue staining device described herein, wherein the microscope slide cartridge assembly comprises a microscope slide comprising the tissue sample; and (b) initiating the tissue staining device to perform a tissue processing protocol, thereby processing the tissue sample. In some embodiments, the tissue processing protocol comprises a chemical staining method. In some embodiments, the tissue processing protocol comprises an immuno-staining method (such as an immunohistochemical staining method or an immunocytochemical staining method). In some embodiments, the tissue processing protocol comprises a tissue dehydration method. In some embodiments, the method further comprises selecting the tissue processing protocol. In some embodiments, the tissue processing protocol comprises a tissue pre-treatment method. In some embodiments, the tissue processing protocol comprises a covertile mounting method.

In some embodiments, the tissue processing protocol, such as an immuno-staining method, comprises any one or more of the following steps (a) dispensing a reagent from the reagent carousel to the microscope slide; (b) rotating the microscope slide carousel such that the reagent fully coats the tissue sample; (c) dispensing a wash buffer from the common liquid dispenser to the microscope slide; and (d) rotating the microscope slide carousel such that a solution comprising the wash buffer is moved to the waste removal outlet of the microscope slide carousel via the waste flow element. In some embodiments, the tissue processing protocol further comprises a blocking step comprising dispensing a blocking reagent to the microscope slide, and rotating the microscope slide carousel such that a solution comprising the blocking buffer is moved to the waste removal outlet of the microscope slide carousel via the waste flow element. In some embodiments, the tissue processing protocol further comprises dispensing a second reagent from the reagent carousel to the microscope slide, wherein the reagent comprises an enzyme-labeled binding agent and the second reagent comprises an enzyme substrate. In some embodiments, the tissue processing protocol further comprises a step of bringing the tissue sample to a pre-determined temperature, such as via heating. In some embodiments, the tissue processing protocol further comprises dispensing a mounting media fluid from the bulk fluid reservoir to the microscope slide, wherein the mounting media flows into the space between the covertile and the slide to establish mounting of a post-staining covertile.

In some embodiments, upon placing a first microscope slide cartridge assembly in a tissue staining device, the device detects the first microscope slide cartridge assembly using a detector and initiates a tissue processing protocol, such as tissue staining method. In some embodiments, the tissue processing protocol is a pre-determined or user-selected tissue processing protocol. In some embodiments, the pre-determined tissue processing protocol is based on the detected microscope slide cartridge assembly, e.g., from information on the label of a microscope side.

In some embodiments, the methods disclosed herein further comprise step(s) of obtaining and/or preparing a tissue sample for a tissue processing method, such as a chemical staining protocol or an immuno-staining protocol. In some embodiments, the methods disclosed herein further comprise freezing a tissue sample. In some embodiments, the methods disclosed herein further comprise sectioning, such as dividing or cutting, a tissue sample. In some embodiments, the methods disclosed herein further comprise fixing a tissue sample.

In some embodiments, the methods disclosed herein comprise a microscope slide covertile mounting method. In some embodiments, the microscope slide covertile mounting method comprises applying mounting media with proper heating and viscosity such that the space between the microscope slide covertile and the microscope slide is filled, thereby completing the microscope slide covertile mounting step at the end of a staining protocol. In some embodiments, the method described herein comprises use of a microscope slide covertile during the entire duration the microscope slide cartridge assembly comprising a tissue sample is loaded in the tissue staining device described herein. In some embodiments, the method described herein comprises use of a microscope slide covertile during a portion of the duration the microscope slide cartridge assembly comprising a tissue sample is loaded in the tissue staining device described herein. In some embodiments, the method described herein does not comprises use of a microscope slide covertile.

In some embodiments, the tissue sample is a fresh tissue sample. In some embodiments, the tissue sample is a frozen tissue sample. In some embodiments, the tissue sample is a fixed tissue sample.

The present disclosure, in some aspects, provides systems comprising a tissue staining device disclosed herein. For example, in some embodiments, the system comprises a tissue staining device and a computer or an electronic control unit, e.g., a mobile phone or tablet computer, wherein the computer or the electronic control unit is coupled to a control unit of the tissue staining device.

Also provided herein are kits comprising any combination of the elements, or a component thereof, disclosed herein. For example, in some embodiments, the present application provides a microscope slide cartridge described herein.

1-59. (canceled)

60. A microscope slide cartridge assembly comprising:
(a) fluid input port positioned on a top side of the microscope slide cartridge assembly;
(b) a gasket positioned on a bottom side of the microscope slide cartridge assembly,
wherein the gasket is configured to form a sealed perimeter on a face of a microscope slide;
(c) one or more walls,
wherein the one or more walls are configured to connect, at least in part, the top side and the gasket thereby forming a chamber over a face of the microscope slide;
(d) one or more clips configured to hold the face of the microscope slide against the gasket;
(e) a portion of a locking clip; and
(f) an inclined waste flow pathway configured to direct fluid flow from the chamber to a waste output element.

61. The microscope slide cartridge assembly of claim 60, wherein the portion of the locking clip is configured to interface with another portion of the locking clip located on a microscope slide cartridge stall.

62. The microscope slide cartridge assembly of claim 60, wherein the fluid input port is on a proximal portion of the microscope slide cartridge assembly, and the portion of the locking clip is on a distal portion of the microscope slide cartridge assembly.

63. The microscope slide cartridge assembly of claim 60, wherein the chamber has a volume of 300 μL or more.

64. The microscope slide cartridge assembly of claim 60, wherein the sealed perimeter formed by the gasket has an area of 1 cm² to 10 cm².

65. The microscope slide cartridge assembly of claim 60, further comprising the microscope slide.

66. The microscope slide cartridge assembly of claim 65, further comprises a microscope slide covertile configured to be positioned on the microscope slide.

67. The microscope slide cartridge assembly of claim 66, wherein the microscope slide covertile comprises one or more downward protruding spacers.

68. The microscope slide cartridge assembly of claim 67, wherein each of the one or more downward protruding spacers has a height of about 0.05 mm to about 0.5 mm.

69. The microscope slide cartridge assembly of claim 66, wherein the microscope slide covertile, when positioned on the microscope slide, forms a space configured to hold about 40 μL to 200 μL of a fluid.

70. A method of staining a tissue sample, the method comprising:
(a) placing a microscope slide cartridge assembly in a microscope slide stall of a tissue staining device, wherein the tissue staining device comprises
(1) a microscope slide carousel,
wherein the microscope slide carousel is configured to rotate on a first axis of rotation, and
wherein the microscope slide carousel comprises at least one microscope slide cartridge stall, and
(2) a reagent assembly comprising:
(i) a reagent carousel,
wherein the reagent carousel is configured to rotate on a d axis of rotation, and
wherein the reagent carousel comprises at least one reagent holder,
(ii) a dispensing actuator, and
wherein the reagent carousel is positioned above the microscope slide carousel, and
where the reagent carousel and the microscope slide carousel are positioned such that when a reagent is placed in the reagent carousel the reagent can flow from the reagent carousel to the microscope slide carousel,
wherein the microscope slide cartridge assembly is interfaced with a microscope slide comprising the tissue sample; and
(b) initiating the tissue staining device to perform a tissue staining protocol thereby staining the tissue sample.

71. The method of claim 70, further comprising selecting the tissue staining protocol.

72. The method of claim 70, wherein the tissue staining protocol comprises a chemical staining protocol.

73. The method of claim 70, wherein the tissue staining protocol comprises an immunohistochemical staining protocol or an immunocytochemical staining protocol.

74. The method of claim 70, wherein the method further comprises a microscope slide mounting method.

75. The method of claim 70, wherein the tissue staining protocol comprises:
(a) dispensing a reagent from the reagent carousel to the microscope slide;
(b) rotating the microscope slide carousel such that the reagent fully coats the tissue sample;
(c) dispensing a wash buffer from the common liquid dispenser to the microscope slide; and
(d) rotating the microscope slide carousel such that a solution comprising the wash buffer is moved to the waste removal outlet of the microscope slide carousel via the waste flow element.
